(19) United States
(12) Patent Application Publication
(10) Pub. No.: US 2019/0004261 A1
(43) Pub. Date: Jan. 3, 2019

(54) CONNECTOR

(71) Applicant: NEUTRIK AG, Schaan (LI)

(72) Inventor: Matthias Koch, Gotzis (AT)

(73) Assignee: NEUTRIK AG, Schaan (LI)

(21) Appl. No.: 16/060,526

(22) PCT Filed: Nov. 25, 2016
(86) PCT No.: PCT/EP2016/078889

§ 371 Date: Jun. 8, 2018

(30) Foreign Application Priority Data
Jan. 25, 2016 (DE) 10 2016 101 255.6

(51) Int. Cl. G02B 6/38; H01R 13/502

(52) U.S. Cl. CPC G02B 6/3898; H01R 13/502; G02B 6/3894; G02B 6/3893; G02B 6/3891

(57) ABSTRACT

A connector (1) having a connector housing (2), a connector insert part (3), and a light guide carrier (4) on the connector side, wherein a mating connector (5) for establishing an optical connection to the connector (1) can be joined with the connector (1) in a joining direction (13), wherein a free end (7) of a connector-side light guide (6) leads into a contact surface (8) of the connector-side light guide carrier (4), wherein the connector insert part (3) can be detachably fixed in the connector housing (2) by a detachable and reconnectable connecting device (9), and the connector insert part (3) has a first recess (10) for detachable and reconnectable fixing of the connector-side light guide carrier (4) on the connector insert part (3) and a second recess (11) for detachable and reconnectable fixing of a light guide carrier (12) of the mating connector (5) on the connector insert part (3), and the connector insert part (3) and the connector-side light guide carrier (4) fixed on the first recess (10) of the connector insert part (3) can be removed together from the connector housing (2) counter to the joining direction (13).

### BACKGROUND

The present invention relates to a connector, in particular a chassis socket, comprising a connector housing and a connector insert part and a connector-side light guide carrier, wherein a mating connector can be joined to the connector in a joining direction in order to establish an optical connection with the connector, wherein at least one connector-side light guide of the connector is fastened to the connector-side light guide carrier and an open end (7) of the connector-side light guide leads into a contact area of the connector-side light guide carrier.

Connectors of the abovementioned type are used to connect cables, which have at least one light guide for data transmission, to another cable or to a device, such as, for example, a television camera or film camera or the like. In order that the data transmission via optical connections of this kind functions beyond connector and mating connector, the open ends of the light guides in the connector have to be kept very clean and have to be able to be cleaned if necessary. To this end, additional tools are required in the case of connectors according to the prior art in order to clean the open ends of the connector-side light guides within the connector.

### SUMMARY

The object of the invention is to improve connectors of the abovementioned kind to the effect that the open end of the connector-side light guide can be cleaned more easily and more effectively.

To this end, the invention proposes, in the case of connectors of the abovementioned kind, that the connector insert part can be releasably fastened in the connector housing by a releasable and reconnectable connecting device, and the connector insert part has a first receptacle for releasably and reconnectably fastening the connector-side light guide carrier to the connector insert part and a second receptacle for releasably and reconnectably fastening a light guide carrier of the mating connector to the connector insert part, and the connector insert part and the connector-side light guide carrier which is fastened to the first receptacle of the connector insert part can be jointly removed from the connector housing against the joining direction.

The invention therefore enables the connector insert part to be removed from the connector housing together with the connector-side light guide carrier which is fastened to it. As a result, the open end of the connector-side light guide can be cleaned outside the connector housing and consequently substantially more easily and more thoroughly. A special tool can be dispensed with in general. Above all, the dirt which is removed from the contact area of the connector-side light guide carrier does not remain in the connector either, as is usually the case at least to a certain extent in the prior art. In this context, particularly preferred design variants of the invention provide that the connector-side light guide carrier, in a position in which it is removed from the connector housing, can be released from the first receptacle of the connector insert part and can be re-fastened to the first receptacle of the connector insert part. Therefore, in the case of these variants, the connector-side light guide carrier can be released from the connector insert part after it has been removed from the connector housing together with the connector insert part. As a result, the contact area of the connector-side light guide carrier, in which the open end of the connector-side light guide which is to be cleaned is located, is particularly easily accessible for the cleaning process. It is particularly expedient when, in the position removed from the connector housing, the open end of the connector-side light guide can be or is arranged in a freely accessible manner and/or outside the connector housing in the contact area of the connector-side light guide carrier which is released from the first receptacle of the connector insert part.

It should not be forgotten here, as stated above, that the connector-side light guide is still fastened to the light guide carrier in this case. The light guide should therefore be long enough that the light guide carrier which is fastened to it can be removed from the connector housing together with the connector insert part in accordance with the invention. In this context, it is expedient when the required degree of freedom of movement and the necessary space are available for the light guide for this purpose so that it can be pushed correspondingly far out of the connector and back into said connector without bending or being damaged.

Most of the components are referred to in the singular in the patent claims and in the above embodiments. This is a purely linguistic simplification and does not exclude individual components of the connector according to the invention also being present in a number greater than one, in the sense of at least one or more than one. This applies, in particular, to the number of connector-side light guides which are fastened to the connector-side light guide carrier and lead by way of their open ends into the contact area of the connector-side light guide carrier. In the case of connectors according to the invention, a plurality of connector-side light guides are generally fastened to the connector-side light guide carrier and lead by way of their open ends into said contact area of the connector-side light guide carrier.

Furthermore, however, connectors according to the invention may of course also be equipped with more than one connector insert part and with more than one connector-side light guide carrier, etc.

The open end of a light guide is the end through which light can exit from the light guide and light can enter the light guide. The open end or the open ends of the light guides in the contact area can be equipped with or without lenses or other means for optically focusing or scattering light. The light guide is an optically conducting fiber which, apart from the open end, is generally surrounded by a casing. Light guides and casings together produce light guide cables which are known per se in the prior art. The light guides can therefore be made, for example, of glass fibers or the like. The term ‘an optical connection’ used above is a connection which is provided for optical data transmission.

A connector and also a mating connector are, generally speaking, used for establishing a connection between at least two cables or at least one cable and a device. In the present case, the cables have one or more light guides. However, they can also comprise electrical lines for data or power transmission. The term ‘mating connector’ has been introduced in order to be able to linguistically differentiate between connector and mating connector. The mating connector is a corresponding different connector, wherein the connector and the mating connector or other connectors can be joined to one another or connected to one another in the joining direction such that the optical connection and possibly also the electrical connection are established. Both the connector according to the invention and the mating connector can be what is referred to as a chassis socket, which could also be called a device socket. Chassis sockets are known per se. They are those connectors which are attached to devices or to the housings thereof. However, both the connector according to the invention and the mating connector can also be designed as what are referred to as cable connectors. Cable connectors are the connectors which are fastened to the abovementioned cable. In order to connect two cables to each other, cable connectors are attached in each case to the two cables which are to be connected to each other. In order to connect a cable to a device or to the housing thereof, a chassis socket is attached to the device and a cable connector is attached to the cable. In general, the connectors could also be called plugs. In this case, joining the connector and mating connector could also be referred to as plug-connection. The connector according to the invention and also the mating connector corresponding to it could however be connected to one another not only by being plugged one into the other but also by being screwed to one another or by other types of connection, or combinations thereof.

The releasable and reconnectable connecting device by way of which the connector insert part can be releasably fastened in the connector housing is a connecting device which is provided and designed in order that the connection established by it can be repeatedly released and re-established. This therefore involves, in particular, a destruction-free type of release and reconnection. Particularly preferably, the releasable and reconnectable connecting device with which the connector insert part is releasably fastened in the connector housing is a bayonet fitting which is known per se. This is a connection in which the parts which are to be connected to one another are inserted one into the other and are rotated in an opposite direction to one another in order to be connected to one another. Said connection is released by rotating and pulling apart said parts in the correspondingly opposite directions.

Alternatively, however, other releasable and reconnectable connecting devices which are known per se and are intended for fastening the connector insert part to the connector housing can also be realized in the invention. An example of this which can be mentioned is screw closures or secured plug-in connections. Secured plug-in connections are those in which the plug-in connection can only be released again when a corresponding securing element is released. Both screw closures and also secured plug-in connections are known per se in the prior art in a large number of embodiments.

In preferred embodiments, both the connector-side light guide carrier and also the light guide carrier of the mating connector are expediently fastened to the connector insert part by a snap-action closure in each case. In this sense, preferred embodiments of the invention therefore provide that the first receptacle has a snap-action closure for releasably and reconnectably fastening the connector-side light guide carrier to the connector insert part, and/or the second receptacle has a snap-action closure for releasably and reconnectably fastening a light guide carrier of the mating connector to the connector insert part.

In order to move the open ends of the light guides in the connector-side light guide carrier on the one hand and the light guide carrier of the mating connector on the other hand into position relative to one another such that the optical transmission functions in the desired form, preferred embodiments of connectors according to the invention provide that the first receptacle and the second receptacle are arranged in or on a connecting channel of the connector insert part for receiving the connector-side light guide carrier and the light guide carrier of the mating connector. In the connecting channel, the connector-side light guide carrier and the light guide carrier of the mating connector can be arranged in a manner situated opposite one another and corresponding to one another such that the desired optical data transmission functions without problems at the desired high quality.

Particularly preferred embodiments of connectors according to the invention are chassis sockets. Particularly in the case of embodiments of this kind, it is expediently provided that the connector housing has a mounting device for fastening the connector housing to a housing of a device. The mounting device may be a screw arrangement or a mounting flange or the like. Particularly in the case of a mounting flange, it can be formed or configured differently. It can have one or more fastening holes.

As already stated above, the cables which are intended to be connected to one another or to a device by connectors according to the invention may also have electrical lines for electrical data and/or power transmission. Power transmission refers, for example, to situations in which the electrical lines serve to supply power or electricity to the device. In this context, it can be provided in the case of connectors according to the invention that the connector insert part additionally has at least one electrical contact.

Connectors according to the invention, whether designed as a chassis socket or as a cable connector, can be used for an extremely wide variety of tasks for optical data transmission or optical connection. However, a particularly preferred form provides that the connector according to the invention is used as a chassis socket for film and/or television cameras. In this case, at least one or more electrical contacts are then also preferably provided in the connector, in addition to the light guide carrier with its light guides, so that both optical and also electrical data transmission and also power supply to the camera can be realized by connectors according to the invention.

A method for cleaning connectors according to the invention provides that the connector insert part and the connector-side light guide carrier, which is fastened to the first receptacle of the connector insert part, can be jointly removed from the connector housing against the joining direction. The connector-side light guide carrier is then expediently released from the first receptacle of the connector insert part. Cleaning of the contact area of the connector-side light guide carrier can then be performed in a particularly simple manner. Further details of methods of this kind can be gathered from the features of the connector according to the invention and its preferred embodiments.

In addition to the connector according to the invention itself, the invention also relates to an arrangement comprising a connector according to the invention and a tool, wherein the tool can be releasably fastened to the connector insert part in the connector housing and the connecting device can be released and reconnected by way of the tool, and the connector insert part, in a manner attached to the tool, can be removed from the connector housing against the joining direction together with the connector-side light guide carrier, which is fastened to the first receptacle of the connector insert part, and can be reinserted into the connector housing in the joining direction. In other words, the tool can therefore be fastened to the connector insert part within the connector housing, whereby the connecting device is then released by the tool, and the connector insert part, in a manner attached to the tool, is removed from the connector housing against the feed direction together with the connector-side light guide carrier. A particularly simple embodiment provides that the tool can be releasably fastened to the second receptacle of the connector insert part.

### BRIEF DESCRIPTION OF THE DRAWINGS

Further features and details of preferred embodiments of the invention are explained in the following description of the figures with reference to an exemplary embodiment according to the invention of a connector, in which:

FIGS. 1 to 3 show different illustrations of the connector housing and of the connector insert part of a connector according to the invention;

FIGS. 4 to 6 show different illustrations of the connector according to the invention of this exemplary embodiment together with a tool, wherein the connector insert part is removed from the connector housing;

FIG. 7 shows an exploded illustration of the various components of the connector according to the invention of this exemplary embodiment; and

FIG. 8 shows the connector according to the invention of this exemplary embodiment, which connector is joined to a mating connector in order to establish an optical connection.

### DETAILED DESCRIPTION

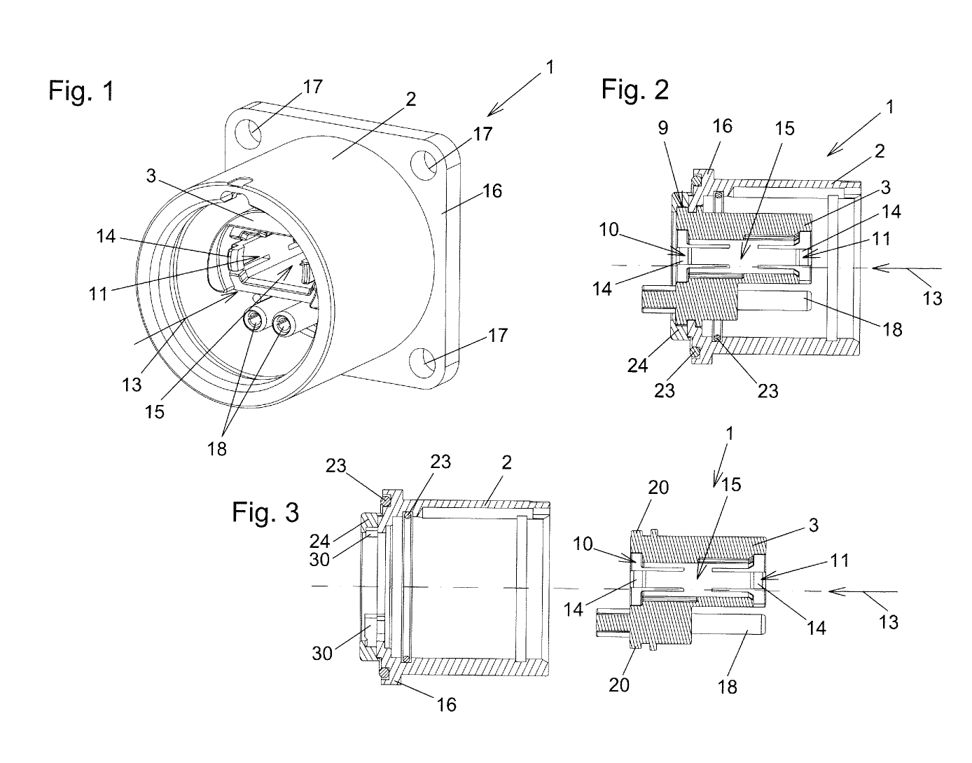

FIG. 1 shows the connector 1 according to the invention which is designed as a chassis socket here. Connectors 1 according to the invention of this kind can be arranged, for example, on film and/or television cameras in order to be able to interchange data with said camera by corresponding optical and electrical signals and to supply power to the camera. FIGS. 1 to 3 illustrate only the connector housing 2 and the connector insert part 3. In FIGS. 1 and 2, the connector insert part is fastened in the connector housing 2 by the releasable and reconnectable connecting device 9, which is designed as a bayonet fitting here. In FIG. 3, the connector insert part 3 is illustrated in a manner removed from the connector housing 2 against the joining direction 13. FIG. 1 shows a perspective illustration. FIGS. 2 and 3 each show a longitudinal section.

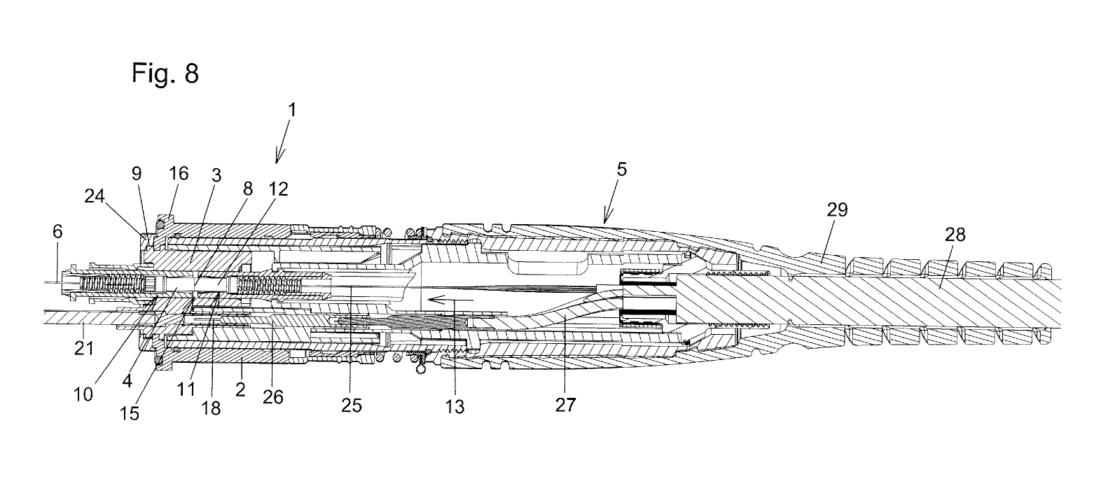

The joining direction 13 is that direction in which a mating connector 5, illustrated in FIG. 8, is combined with the connector 1, or inserted into said connector, in order to establish the optical connection.

The perspective view according to FIG. 1 shows a view into the open end of the connector housing 2. The connector insert part 3 and the electrical contacts 18 which are likewise present here in this exemplary embodiment can be seen there. The connecting channel 15 with the second receptacle 11, by which a light guide carrier 12 of the mating connector 5, which light guide carrier is pushed into the connecting channel 15, can be fastened to the connector insert part 3, as illustrated in more detail in FIG. 8, can be seen in the connector insert part 3. In the exemplary embodiment shown, this fastening operation is performed by the snap-action closures 14 which are equipped with undercuts and are designed as spring tongues.

A mounting device 16 in the form of a mounting flange with fastening holes 17 is located on the outside of the connector housing 2. The connector housing 2 and therefore also the connector 1 according to the invention can be attached in a manner which is known per se to a housing of a corresponding device, such as a still camera and/or film camera, by the mounting flange and the fastening holes 17.

In the longitudinal section according to FIG. 2, the connector insert part 3 is located, as said, in the position in which it is connected to the connector housing 2. The releasable and reconnectable connecting device 9 used for this purpose is designed as a bayonet fitting. It comprises, firstly, the pins 20 on the connector insert part 3 and, secondly, the pin receptacles 30 on the connector housing 2. The pins 20 and the pin receptacles 30 are designed in a manner which is known per se such that the connector insert part 3 can be pushed into the connector housing 2 in the joining direction 13 from the position according to FIG. 3, and the connection can then be closed by rotation about an axis which is parallel to the joining direction 13. This connecting device 9 is then released by rotating the connector insert part 3 relative to the connector housing 2 in the opposite direction and by correspondingly pulling the connector insert part 3 out of the connector housing 2 against the joining direction 13.

FIGS. 2 and 3 also show sealing rings 23 which can be designed in a manner known per se as in the prior art. For production-related reasons, the housing ring 24, which is provided with the pin receptacles 30 here, can be designed as a part which is initially separate and is then fastened to the rest of the connector housing 2. Here, in this exemplary embodiment, the housing ring 24 is part of the connector housing 2 in any case.

FIGS. 2 and 3 furthermore also show the first receptacle 10 with its snap-action closures 14. The first receptacle 10 serves for releasably fastening the connector-side light guide carrier 4 to the connector insert part 3. The first receptacle 10 for the connector-side light guide carrier 4 and the second receptacle 11 for the light guide carrier 12 of the mating connector 5 are arranged on opposite sides of the connecting channel 15 of the connector insert part 3.

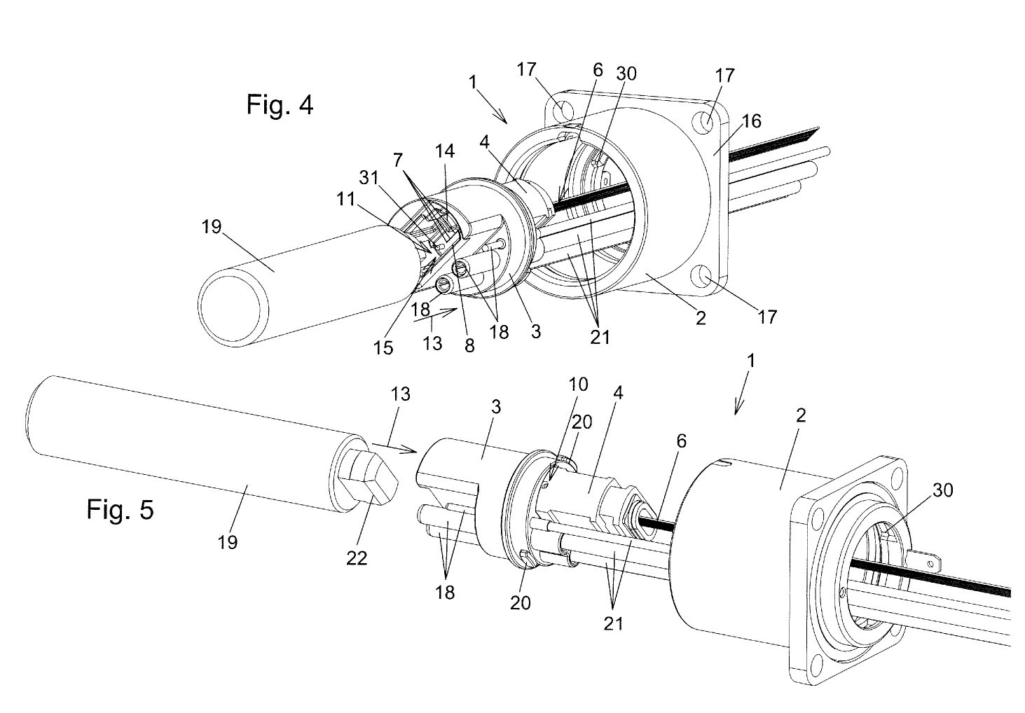

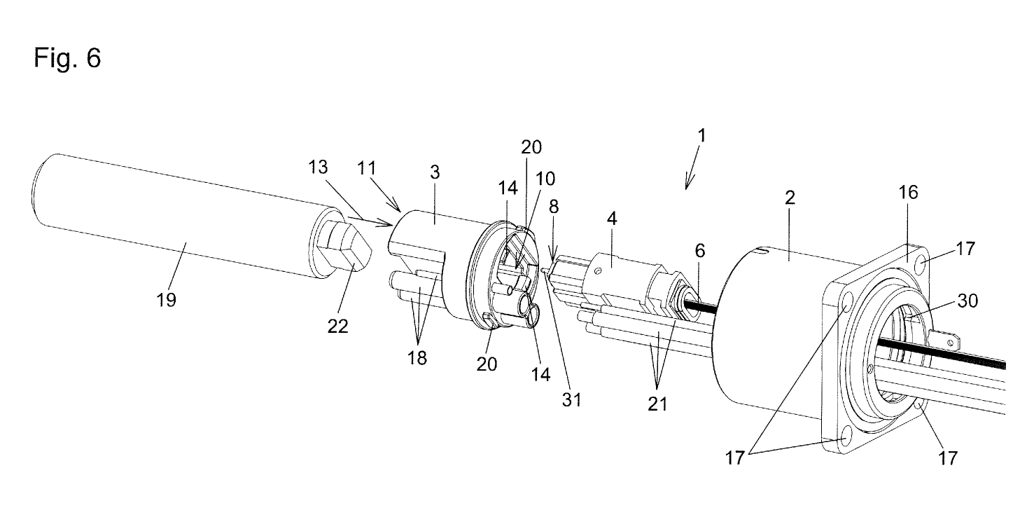

FIGS. 4, 5 and 6 each show the connector insert part 3 in a manner removed from the connector housing 2 against the joining direction 13. In FIGS. 4 and 5, the connector-side light guide carrier 4 is fastened to the first receptacle 10 of the connector insert part 3. The connector-side electrical lines 21 are connected to the electrical contacts 18 of the connector insert part 3. The electrical lines 21 are routed through the connector housing 2 together with the connector-side light guides 6 which are connected to one another as a cable tie here. Both the connector-side light guides 6 and also the electrical lines 21 are designed to be so long that the connector insert part 3 can be removed from the connector housing 2 against the joining direction 13 to a corresponding extent, as is also illustrated in FIGS. 4 and 5. FIG. 4 shows, looking into the connecting channel 15, the contact area 8 of the connector-side light guide carrier 4 with the open ends 7 of the connector-side light guides 6, said ends being arranged in a row there. It can be seen from the number of open ends 7 that there are a plurality of connector-side light guides 6 which are fastened to the connector-side light guide carrier 4 and joined together. In FIG. 6, the connector-side light guide carrier 4 is detached from the connector insert part 3. As a result, the contact area 8 of the connector insert part 3 is freely accessible, so that the contact area 8 with the open ends 7 of the connector-side light guides 6 can be cleaned particularly easily and thoroughly outside the connector housing 2.

FIGS. 4, 5 and 6 also show the tool 19. In this exemplary embodiment, said tool is fitted with an adapter 22 by way of which the tool 19 can be fastened to the second receptacle 11 by its snap-action closures 14 in the connecting channel 15 of the connector insert part 3 such that the connecting device 9, which is designed as a bayonet fitting here, can be released by the tool 19 and then the connector insert part 3, which is attached to the tool 19, together with the connector-side light guide carrier 3 which is fastened to said connector insert part or to the first receptacle 10 of said connector insert part, can be removed from the connector housing 2, this then resulting in the position according to FIGS. 4 and 5. In this position, the connector-side light guide carrier 4 can then be withdrawn in order to be able to perform cleaning of the contact area 8 of the connector-side light guide carrier 4 in a particularly simple manner. The connector-side light guide carrier 4 is then mounted on the connector insert part 3 by reinserting the connector-side light guide carrier 4 into the connecting channel 15, as a result of which the connector-side light guide carrier 4 is then re-fastened to the connector insert part 3 using the first receptacle 10. The connector insert part 3, with the connector-side light guide carrier 4 fastened to it, is then reinserted into the connector housing 2 in the joining direction 13 by the tool 19 which is fastened to the second receptacle 11. The pins 20 of the connecting device 9 are then screwed into the pin receptacles 30 of the connecting device 9 again by rotating the connector insert part 3, together with the connector-side light guide carrier 4, about a rotation axis parallel to the joining direction 13, so that this connecting device 9 can be closed again and the connector insert part 3 is then fastened, together with the connector-side light guide carrier 4, in the connector housing 2. The tool 19 can then be withdrawn from the connector insert part 3 again against the joining direction 13 by releasing the snap-action closures 14 of the second receptacle 11.

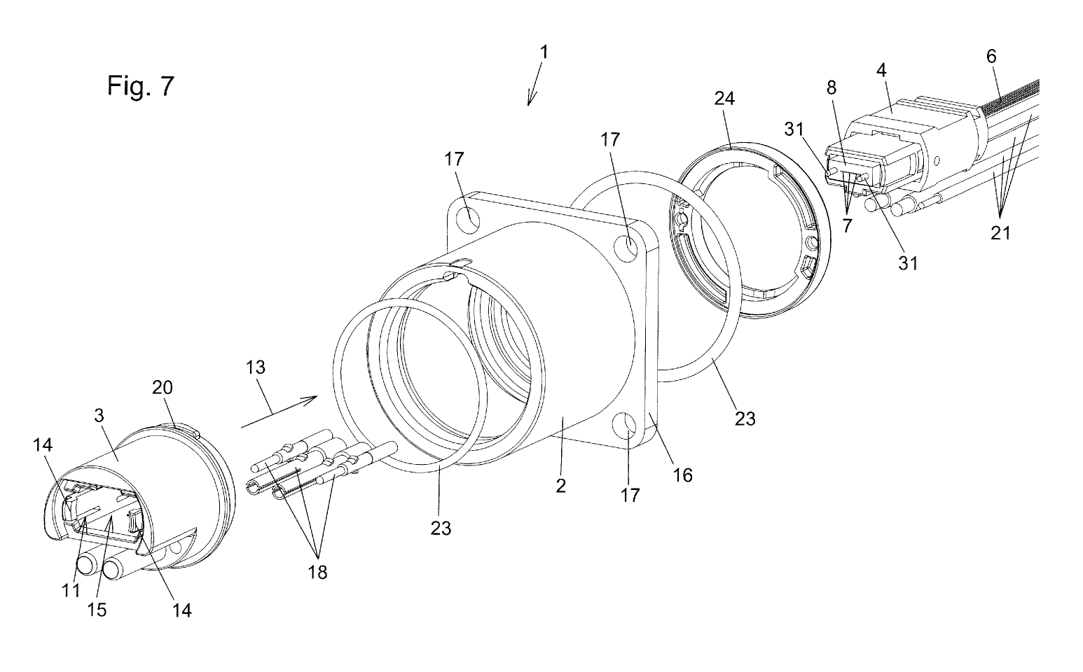

FIG. 7 shows the above-described components of the connector 1 according to the invention in an exploded illustration. This figure particularly clearly shows that the connector insert part 3 has a total of four electrical contacts 18. By way of example, two of said electrical contacts can be used for electrical data transmission and the other two can be used for supplying power to the device, such as, for example, a camera or the like.

FIG. 8 now additionally shows, in a longitudinal section, how a corresponding mating connector 5 has been joined and therefore connected in the joining direction 13 to the connector 1 according to the invention, as has already been described. Here, the mating connector 5 is designed as a cable connector which has fastened to its rear end the cable 28 which is routed through the cable bushing 29. The electrical lines 27 and light guides 25 of the mating connector 5 which lead into the mating connector 5 are routed in the cable 28, but this is not illustrated in detail here.

The section according to FIG. 8 firstly clearly shows how the electrical contacts 18 of the connector insert part 3 of the connector 1 according to the invention are plugged together and therefore connected to the electrical contacts 26 of the mating connector 5. Secondly, said section also clearly shows how the connector-side light guide carrier 4 and the light guide carrier 12 of the mating connector 5 are arranged in a manner situated opposite one another in the connecting channel 15 such that the open ends 7 of the connector-side light guides 6 are arranged in alignment with corresponding open ends, not illustrated in detail here, of the light guides 25 of the mating connector 5, so that the optical data transmission from the connector-side light guides 6 to the light guide 25 of the mating connector 5, and in the opposite direction, functions effectively. To this end, the connector-side light guide carrier 4 and the light guide carrier 12 of the mating connector 5 are oriented in an optimum manner in relation to one another in the connecting channel 25. In addition, centering pins 31, as shown in FIGS. 4 and 6, can also be used in order to center the connecting-side light guide carrier 4 and the light guide carrier 12 of the mating connector 5. These centering pins engage into corresponding centering pin receptacles, not illustrated in detail here, in the respectively other or corresponding light guide carrier 4 or 12 in the joined position illustrated in FIG. 8.

### KEY TO THE REFERENCE NUMERALS

1 Connector
2 Connector housing
3 Connector insert part
4 Connector-side light guide carrier
5 Mating connector
6 Connecting-side light guide
7 Open end
8 Contact area
9 Connecting device
10 First receptacle
11 Second receptacle
12 Light guide carrier
13 Joining direction
14 Snap-action closure
15 Connecting channel
16 Mounting device
17 Fastening hole
18 Electrical contact
19 Tool
20 Pin
21 Electrical line
22 Adapter
23 Sealing ring
24 Housing ring
25 Light guide
26 Electrical contact
27 Electrical line
28 Cable
29 Cable bushing
30 Pin receptacle
31 Centering pin

1. A connector, comprising:
a connector housing;
a connector insert part;
a connector-side light guide carrier;
wherein the connector is adapted to receive a mating connector in a joining direction in order to establish an optical connection;
at least one connector-side light guide is fastened to the connector-side light guide carrier and includes an open end leads into a contact area of the connector-side light guide carrier;
the connector insert part is releasably fastened in the connector housing by a releasable and reconnectable connection;
the connector insert part has a first receptacle for releasably and reconnectably fastening the connector-side light guide carrier to the connector insert part and a second receptacle that is adapted to releasably and reconnectably fasten a light guide carrier of the mating connector to the connector insert part; and
the connector insert part and the connector-side light guide carrier which is fastened to the first receptacle of the connector insert part are jointly removable from the connector housing in a direction opposite to the joining direction.

2. The connector as claimed in claim 1, wherein the connector-side light guide carrier, in a position removed from the connector housing, is releasable from the first receptacle of the connector insert part and is re-fastenable to the first receptacle of the connector insert part.

3. The connector as claimed in claim 1, wherein in a position removed from the connector housing, the open end of the connector-side light guide is arrangeable at least one of in a freely accessible manner or outside the connector housing in the contact area of the connector-side light guide carrier which is released from the first receptacle of the connector insert part.

4. The connector as claimed in claim 1, wherein the releasable and re-connectable connection, by which the connector insert part is releasably fastenable in the connector housing, is at least one of a bayonet fitting, a screw closure, or a secured plug-in connection.

5. The connector as claimed in claim 1, wherein the first receptacle has a snap-action closure for releasably and reconnectably fastening the connector-side light guide carrier to the connector insert part.

6. The connector as claimed in claim 1, wherein the first receptacle and the second receptacle are arranged in or on a connecting channel of the connector insert part for receiving the connector-side light guide carrier and that is adapted to receive the light guide carrier of the mating connector.

7. The connector as claimed in claim 1, wherein the connector housing has a mounting device for fastening the connector housing to a housing of a device.

8. The connector as claimed in claim 1, wherein the connector insert part further comprises at least one electrical contact.

9. An arrangement comprising a connector as claimed in claim 1 and a tool (19), the tool is releasably fastenable to the connector insert part in the connector housing and the connecting device is releasable and reconnectable using the tool, and the connector insert part, in a manner attached to the tool, is removable from the connector housing in the direction opposite to the joining direction together with the connector-side light guide carrier, which is fastened to the first receptacle of the connector insert part, and is reinsertable into the connector housing in the joining direction.

10. The arrangement as claimed in claim 9, wherein the tool is releasably fastenable to the second receptacle of the connector insert part.

11. The connector as claimed in claim 1, wherein the second receptacle has a snap-action closure that is adapted to releasably and reconnectably fasten a light guide carrier of the mating connector to the connector insert part.
